(19) United States
(12) Patent Application Publication
(10) Pub. No.: US 2020/0073478 A1
(43) Pub. Date: Mar. 5, 2020

(54) VEHICLE AND CONTROL METHOD THEREOF

(71) Applicants: HYUNDAI MOTOR COMPANY, Seoul (KR); KIA MOTORS CORPORATION, Seoul (KR)

(72) Inventors: Daeyun An, Anyang-si (KR); Dong-Seon Chang, Hwaseong-si (KR); Seunghyun Woo, Seoul (KR)

(73) Assignees: HYUNDAI MOTOR COMPANY, Seoul (KR); KIA MOTORS CORPORATION, Seoul (KR)

(21) Appl. No.: 16/216,615

(22) Filed: Dec. 11, 2018

(30) Foreign Application Priority Data
Sep. 4, 2018 (KR) 10-2018-0105293

(51) Int. Cl. G06F 3/01; G10L 25/63; G06F 3/16; B60K 35/00

(52) U.S. Cl. CPC G06F 3/017; G10L 25/63; G06F 3/167; B60K 35/00; B60K 2350/1024; B60K 2350/1052; B60K 2350/1056; B60K 2350/1044; G06F 2203/011

(57) ABSTRACT

A vehicle, and a control method thereof, prevents and/or suppresses a user's negative emotions by providing necessary feedback based on the user's emotional state. The vehicle includes a sensing unit configured to acquire user emotion information indicating a user's emotional state using at least one sensor, a storage configured to store situation information representing the numbers of expressions of respective emotional states in each unit situation and user long-term information representing the numbers of expressions of the respective emotional states for a unit period based on the acquired user emotion information, and a controller configured to control feedback devices provided in the vehicle to control the user's emotional state based on at least one of the situation information, the user long-term information, and the user emotion information.

### CROSS-REFERENCE TO RELATED APPLICATION

This application claims priority to and the benefit of Korean Patent Application No. 10-2018-0105293, filed on Sep. 4, 2018 in the Korean Intellectual Property Office, the disclosure of which is incorporated herein by reference.

### BACKGROUND

### 1. Field

Embodiments of the present disclosure relate to a vehicle, which provides feedback to a user based on a user's emotional state, and to a control method thereof.

### 2. Description of the Related Art

Technologies that determine emotions of a user within a vehicle to increase the user's convenience according to the determined user's emotions have been developed. In order to determine the user's emotions, technologies using biometrics have been developed.

In general, a user within a vehicle may feel negative emotions, such as anger, depression, irritation, excitement, etc., during driving of the vehicle. Negative emotional states of users increase rates of traffic accidents caused by, for example, reckless or retaliatory driving.

As such, the user's emotional state is an important factor in influencing safe driving. Technology that may prevent and/or suppress the user's negative emotions may be required.

### SUMMARY

Therefore, it is an aspect of the present disclosure to provide a vehicle that determines a user's emotional state and provides feedback to the user based on the determined user's emotional state to prevent and/or suppress the user's negative emotions, and a to control method thereof.

Additional aspects of the disclosure are set forth in part in the description that follows and in part will become apparent from the description or may be learned by practice of the disclosure.

In accordance with one aspect of the present disclosure, a vehicle includes a sensing unit using at least one sensor and configured to acquire user emotion information indicating a user's emotional state. The vehicle includes a storage configured to store situation information representing the numbers of expressions of respective emotional states in each unit situation and user long-term information representing the numbers of expressions of the respective emotional states for a unit period based on the acquired user emotion information. The vehicle includes a controller configured to control feedback devices provided in the vehicle to control the user's emotional state based on at least one of the situation information, the user long-term information, and the user emotion information.

The vehicle may further include a display configured to display the user's emotional state based on the user emotion information.

The controller may compare the situation information corresponding to a current unit situation with a first threshold value. When a first emotional state having the number of expressions, which is equal to the first threshold value or more, and including a negative emotion factor indicating the user's negative emotional state is present the controller may control the feedback devices to reduce the negative emotion factor influencing the first emotional state. The unit situation may include at least one of a driving situation in a specific time zone, a driving situation in a specific distance section, and a driving situation in a specific area.

When the first emotional state having the number of expressions, which is equal to the first threshold value or more, is not present and a value of a negative emotion factor influencing a second emotional state indicated by current user emotion information is a reference value or more, the controller may control the feedback devices to reduce the negative emotion factor influencing the second emotional state.

When a value of a negative emotion factor influencing an emotional state indicated by user emotion information acquired after control of the feedback devices is equal to the reference value or more, the controller may control the feedback devices to reduce the negative emotion factor influencing the emotional state.

When the current unit situation is changed to another unit situation, the controller may update the situation information corresponding to the unit situation prior to the change based on the user emotion information measured in the unit situation prior to the change.

The controller may compare the user long-term information with a second threshold value. When a third emotional state having the number of expressions, which is equal to the second threshold value or more, and including a negative emotion factor indicating the user's negative emotional state is present, the controller may control the feedback devices to reduce the negative emotion factor influencing the third emotional state.

The vehicle may further include an input unit configured to receive user input. When the third emotional state is present in plural, the controller may select one third emotional state based on at least one of the greatest number of expressions and the user input regarding the third emotional states.

The controller may control the feedback devices based on the user input with respect to a message to suggest control of the feedback devices.

The feedback devices may include at least one of a communicator configured to make a call, a speaker configured to reproduce music and an emotion release message, a display configured to display an emotion release image, a side window opening and closing device configured to open and close a side window, and an air conditioner configured to control an internal temperature of the vehicle.

In accordance with another aspect of the present disclosure, a control method of a vehicle includes acquiring user emotion information indicating a user's emotional state using at least one sensor. The control method includes storing situation information representing the numbers of expressions of respective emotional states in each unit situation and user long-term information representing the numbers of expressions of the respective emotional states for a unit period based on the acquired user emotion information. The control method includes controlling feedback devices provided in the vehicle to control the user's emotional state based on at least one of the situation information, the user long-term information, and the user emotion information.

The control method may further include displaying the user's emotional state based on the user emotion information.

The control method may further include comparing the situation information corresponding to a current unit situation with a first threshold value. When a first emotional state having the number of expressions, which is equal to the first threshold value or more, and including a negative emotion factor indicating the user's negative emotional state is present, the feedback devices are controlled to reduce the negative emotion factor influencing the first emotional state. The unit situation may include at least one of a driving situation in a specific time zone, a driving situation in a specific distance section, and a driving situation in a specific area.

The control method may further include, when the first emotional state having the number of expressions, which is equal to the first threshold value or more, is not present and a value of a negative emotion factor influencing a second emotional state indicated by current user emotion information is equal to a reference value or more, controlling the feedback devices to reduce the negative emotion factor influencing the second emotional state.

The control method may further include, when a value of a negative emotion factor influencing an emotional state indicated by user emotion information acquired after control of the feedback devices is equal to the reference value or more, controlling the feedback devices to reduce the negative emotion factor influencing the emotional state.

The control method may further include, when the current unit situation is changed to another unit situation, updating the situation information corresponding to the unit situation prior to the change based on the user emotion information measured in the unit situation prior to the change.

The control method may further include comparing the user long-term information with a second threshold value. When a third emotional state having the number of expressions, which is equal to the second threshold value or more, and including a negative emotion factor indicating the user's negative emotional state is present, the feedback devices may be controlled to reduce the negative emotion factor influencing the third emotional state.

The control method may further include receiving user input. When the third emotional state is present in plural, one third emotional state is selected based on at least one of the greatest number of expressions and the user input regarding the third emotional states.

The control method may further include controlling the feedback devices based on the user input with respect to a message to suggest control of the feedback devices.

The feedback device may include at least one of a communicator configured to make a call, a speaker configured to reproduce music and an emotion release message, a display configured to display an emotion release image, a side window opening and closing device configured to open and close a side window, and an air conditioner configured to control an internal temperature of the vehicle.

### BRIEF DESCRIPTION OF THE DRAWINGS

These and/or other aspects of the disclosure will become apparent and more readily appreciated from the following description of the embodiments taken in conjunction with the accompanying drawings of which:

FIG. 1 is a perspective view illustrating an external appearance of a vehicle in accordance with one embodiment;

FIG. 2 is a control block diagram of the vehicle in accordance with one embodiment;

FIG. 3 is a view illustrating an inside of the vehicle in accordance with one embodiment;

FIG. 4 is a view illustrating a unit situation in accordance with one embodiment;

FIG. 5 is a table illustrating situation information representing numbers of expressions of respective emotional states in each unit situation in accordance with one embodiment;

FIGS. 6A and 6B are views illustrating user's emotional state guide screens displayed on a display of the vehicle in accordance with one embodiment;

FIG. 7 is a table illustrating user long-term information representing the numbers of expressions of respective emotional states for a unit period in accordance with one embodiment;

FIGS. 8A and 8B are views illustrating screens displayed on the display to receive user selection in the vehicle in accordance with one embodiment;

FIG. 9 is a flowchart illustrating a control method of a vehicle in accordance with one embodiment; and

FIG. 10 is a flowchart illustrating another control method of a vehicle in accordance with one embodiment.

### DETAILED DESCRIPTION

Reference is made in detail to the embodiments of the present disclosure, examples of which are illustrated in the accompanying drawings, wherein like reference numerals refer to like elements throughout.

In the following description of the present disclosure, the same or similar elements are denoted by the same reference numerals even though they are depicted in different drawings. In the following description of the present disclosure, all elements of the embodiments are not described. A detailed description of general elements in the art or redundant elements in the embodiments are omitted when it may make the subject matter of the present disclosure rather unclear.

In the following description of the present disclosure it will be understood that when a part is “connected to” another part, the part can be directly connected to the other part or be indirectly connected to the other part. Indirect connection can include connection through a wireless communication network.

In addition, it will be understood that when a part “includes” an element, the part may further include other elements. The other elements are not excluded unless stated otherwise.

It will be understood that a singular expression may include a plural expression unless there is a contextually clear exception.

Further, it will be understood that terms “unit”, “part”, “block”, “member”, and “module” may mean units to process at least one function or operation. For example, these terms may mean at least one hardware, such as a field-programmable gate array (FPGA), an application specification integrated circuit (ASIC), etc., at least one software stored in a memory, or at least one process processed by a processor.

Marks attached to respective operations are used to discriminate the respective operations and do not represent order among the respective operations. The respective operations may be executed in a different order than described herein, unless a specific order is contextually clearly described.

Hereinafter, a vehicle and a control method thereof in accordance with embodiments are described in detail with reference to the accompanying drawings.

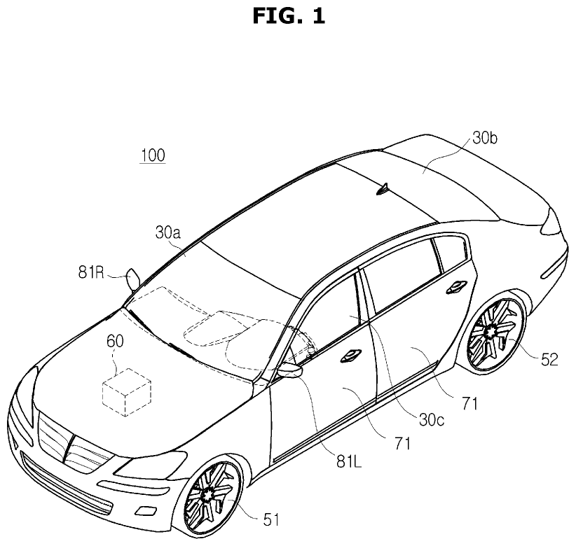

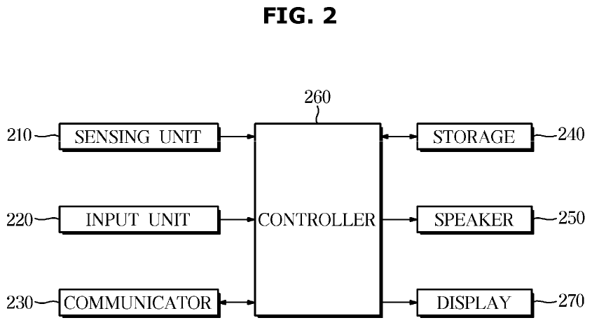

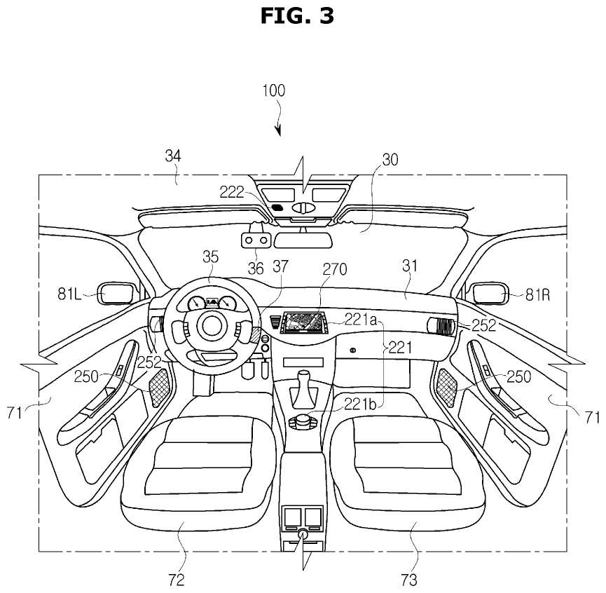

FIG. 1 is a perspective view illustrating an external appearance of a vehicle in accordance with one embodiment. FIG. 2 is a control block diagram of the vehicle in accordance with one embodiment. FIG. 3 is a view illustrating an inside of the vehicle in accordance with one embodiment.

Referring to FIG. 1, a vehicle 100 in accordance with one embodiment includes front wheels 51 and rear wheels 52 configured to move the vehicle 100, doors 71 configured to shield the inside of the vehicle 100 from the outside, a windshield 30a configured to provide a front view of the vehicle 100 to a driver, a rear window 30b configured to provide a rear view of the vehicle 100 to the driver, and side mirrors 81L and 81R configured to provide rear views at sides of the vehicle 100 to the driver. Further, side windows 30c configured to provide side views of the vehicle 100 may be provided at upper portions of the doors 71.

Further, a drive system 60 provided within the vehicle 100 provides rotational force to the front wheels 51 or the rear wheels 52 so that the vehicle 100 moves.

The drive system 60 provides rotational force to the front wheels 51 when the vehicle 100 is a front wheel drive type and provides rotational force to the rear wheels 52 when the vehicle 100 is a rear wheel drive type. Further, the drive system 60 may provide rotational force to both the front wheels 51 and the rear wheels 52 when the vehicle 100 is a four wheel drive type.

The drive system 60 may employ an engine, which generates rotational force by burning fossil fuel, a motor, which generates rotational force by receiving power from a battery, or a hybrid method, which both the engine and the motor are provided so that the engine and the motor are selectively used.

In addition, the vehicle 100 may further include sensing devices, such as a proximity sensor configured to sense obstacles or other vehicles around the vehicle 100, a rain sensor configured to sense rain and an amount of rainfall, an RPM sensor configured to sense RPM, a position sensor configured to sense a current position of the vehicle 100 by receiving GPS signals, and a speed sensor configured to sense a dynamic state of the vehicle 100.

Referring to FIG. 2, the vehicle 100 in accordance with one embodiment may include a sensing unit 210 configured to acquire user emotion information indicating a user's emotional state using sensors, an input unit 220 configured to receive user input, and a communicator 230 configured to receive information, such as external information of the vehicle 100, etc., from an external server or to make a call.

The external information of the vehicle 100 may include all external information relating to driving of the vehicle 100. Specifically, the external information of the vehicle 100 may include current time information, GPS position information, map information, traffic situation information of a road on which the vehicle 100 is driven, road information, and weather information.

The communicator 230 may transmit and receive information to and from an external server and make a call through a wireless communication method, such as a global system for mobile communication (GSM), code division multiple access (CDMA), wideband code division multiple access (WCDMA), a universal mobile telecommunications system (UMTS), time division multiple access (TDMA), long term evolution (LTE), 4G, 5G, etc., in addition to a Wi-Fi module or wireless broadband module.

Further, the communicator 230 may include a short range communication module, such as a Bluetooth module or an NFC module, and communicate with the user's mobile electronic device.

The communicator 230 may acquire phone numbers of friends or family members stored in the user's mobile electronic device by communicating with the user's mobile electronic device.

The communication method is not limited to the above-described methods. Any communication method through which the communicator 230 transceives information with the external server or makes a call may be used.

Further, the vehicle 100 in accordance with one embodiment may include a storage 240 configured to store various pieces of information regarding the user and the vehicle 100, speakers 250 configured to reproduce music to control the user's emotional state, and a display 270 configured to display a screen indicating the user's emotional state based on the user emotion information or to receive user selection. The controller 260 configured to control feedback devices provided in the vehicle 100 to control the user's emotional state based on the user emotion information received from the sensing unit 210 and the information stored in the storage 240.

The storage 240 may be implemented as at least one of a non-volatile memory, such as a cache, a read only memory (ROM), a programmable ROM (PROM), an erasable programmable ROM (EPROM), an electrically erasable programmable ROM (EEPROM) or a flash memory, a volatile memory, such as a random access memory (RAM), and a storage medium, such as a hard disk drive (HDD) or a CD-ROM, to store various pieces of information without being limited thereto.

The controller 260 may include at least one memory configured to store a program performing an operation, which is described below, and at least one processor configured to execute the stored program.

The sensing unit 210, the storage 240, and the controller 260 included in the vehicle 100 may share memories or processors or use separate memories or processors. Hereinafter, remaining elements are described in detail.

Referring to FIG. 3, the display 270 may be provided on a center fascia, i.e., a central region of a dashboard 31 within the vehicle 100. For example, the display 270 may be an element of a head unit or an element of a navigation system provided separately from the head unit.

The head unit may process an audio signal and a video signal, output the processed signals, and perform a navigation function. Accordingly, the head unit is referred to as an audio video navigation (AVN) device.

The display 270 may display a screen indicating the user's emotional state based on the user emotion information or receive user selection for executing feedback, as described above. In addition, the display 270 may further display a screen to perform a navigation function, an audio function, a video function, or a call function.

The display 270 may be implemented as any one of various displays, such as a liquid crystal display (LCD), a light emitting diode (LED) display, a plasma display panel (PDP), an organic light emitting diode (OLED) display, a cathode ray tube (CRT), etc.

The user input may be received through operation of an input device, such as a button or a touchpad, or be received through voice. Accordingly, the input unit 220 may include an operating unit 221 and a microphone 222.

The operating unit 221 may include buttons 221a provided around the display 270 and a jog-shuttle 211b provided between a driver's seat 72 and a front passenger's seat 73.

The operating unit 221 may include a touchpad provided on the front surface of the display 270. The touchpad and the display 270 may constitute a touchscreen. The user may input instructions by touching the display 270.

The operating unit 221 may further include a button provided on a steering wheel 35. The vehicle 100 in accordance with one embodiment is not limited to the operating unit 221 configured to receive the user input.

Further, although the microphone 222 to receive the user's voice may be mounted on a head lining 34 to effectively receive voice, as shown in FIG. 3, the scope and spirit of the embodiments of the present disclosure are not limited thereto. The microphone 222 may be mounted on the dashboard 31 or be mounted on the steering wheel 35. In addition, the microphone 222 may be mounted at any position that is proper to receive the user's voice.

The speakers 250 may be provided to output audio within the vehicle 100.

The speakers 250 may reproduce music to control the user's emotional state and reproduce an emotion release message and output a warning sound to various risks, which may be generated in the vehicle 100, an audio sound included in multimedia content, a voice to provide user desired information or services, etc. For example, the speakers 250 may be provided on the inner surface of the door 71.

Further, an air conditioner may be provided within the vehicle 100 to perform heating and cooling operations and control the internal temperature of the vehicle 100 by exhausting heated or cooled air to the outside through air vents 252.

Although FIG. 3 illustrates that one air vent 252 is provided at each of the driver's seat 72 and the front passenger's seat 73, the present disclosure is not limited thereto. The air vents 252 may be provided at various positions within the vehicle 100.

In addition to the head unit, modules having various functions, such as an engine control module (ECM), a body control module (BCM), a transmission control module (TCM), an anti-lock brake control module, a door control module, an airbag control module, various sensor modules, etc., are provided within the vehicle 100.

These modules may be included in electronic control units (ECUs), which control the respective modules, and acquire data necessary to control the same from various sensors provided within the vehicle 100.

The ECUs and the sensors may transmit and receive signals to and from each other through communication protocols within the vehicle 100. Here, at least one of the communication protocols, such as a controller area network (CAN), a local interconnection network (LIN), FlexRay, Ethernet, etc., may be used.

The user within the vehicle 100 may feel negative emotions, e.g., fatigue, excitement, anger, depression, irritation, etc., during driving. Such negative emotions may influence a driving state of the vehicle 100. The sensing unit 210 may sense a user's emotional state during driving and acquire user emotion information indicating the user's emotional state. The controller 260 may provide feedback to release the user's negative emotions based on the acquired user emotion information. Specifically, the controller 260 may control feedback devices to release the user's negative emotions based on the user emotion information. That is, the vehicle 100 in accordance with one embodiment may measure the user's emotional state and provide feedback corresponding to the user's emotional state, thereby promoting release of the user's negative emotions and contributing to improvement in user satisfaction while assuring safe driving. Hereinafter, related embodiments are described in detail.

The controller 260 may execute feedback to release the user's negative emotional state based on user emotion information indicating the user's emotional state. Here, the user may include at least one of a driver and a passenger of the vehicle 100.

Referring to FIG. 3, various biometric devices may be provided within the vehicle 100 to determine the user's emotion. The biometric devices may include a camera 36 configured to recognize the user's face or hand gesture, an electrode 37 configured to measure the user's heartbeat, an electroencephalogram (EEG) measuring instrument (not shown) configured to measure the user's EEG, etc. Means for biometrics are not limited thereto.

The sensing unit 210 may sense the user's emotional state using sensors provided within the vehicle 100 and transmit user emotion information indicating the user's emotional state to the controller 260.

The sensing unit 210 may include various sensors to sense and acquire the user's emotional state. For example, the sensing unit 210 may include at least one of a Near Infrared Spectroscopy (NIRS) measuring instrument configured to optically measure a brain activation state, a galvanic skin response (GSR) measuring instrument configured to measure the user's skin state, a Heart Rate (HR) measuring instrument configured to measure the user's hear rate, a face analyzer configured to analyze the user's face state, and an eye tracker configured to track positions of the user's eyes. Further, the sensors of the sensing unit 210 are not limited to the above-described instruments and devices and may include any sensor that may measure a human physical state.

Further, the sensing unit 210 may include a sensor, which is worn on a part of the user's body to measure the user's electroencephalogram, as a wearable device.

In more detail, the sensing unit 210 may measure the user's electroencephalogram (EEG) using an electroencephalogram (EEG) measuring instrument and sense the user's emotional state based on the measured user's EEG.

The sensing unit 210 may analyze the measured user's EEG and extract emotion factors. The emotion factors may include positive emotion factors indicating the user's positive emotional states and negative emotion factors indicating the user's negative emotional states. Further, the emotion factor may be expressed as a value indicating a degree of an emotion.

The positive emotion factors may include an enjoyment factor, a pleasure factor, a joy factor, etc. The negative emotion factors may include a fatigue factor, an anger factor, an irritation factor, a depression factor, etc. The emotion factors are not limited thereto. Any emotion factor that indicates a human emotional state may be used.

The sensing unit 210 may sense the user's emotional state based on the extracted emotion factors. For example, when a value of the anger factor is higher than those of other emotion factors, the sensing unit 210 may determine that the user's emotional state is anger and acquire user emotion information indicating that the user's emotional state is anger. The user emotion information may include emotion factors to indicate the user's emotional state.

The controller 260 may recognize the user's emotional state based on the user emotion information acquired by the sensing unit 210. Specifically, the controller 260 may recognize that the user's emotional state is anger when the user emotion information includes the anger factor.

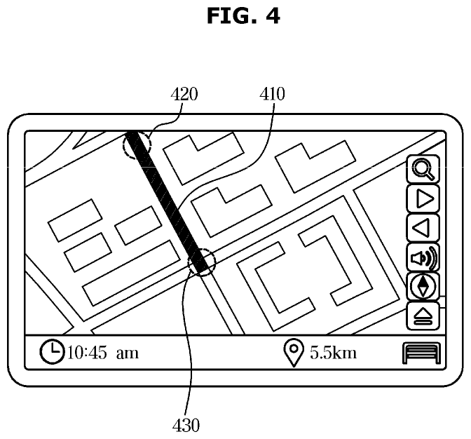

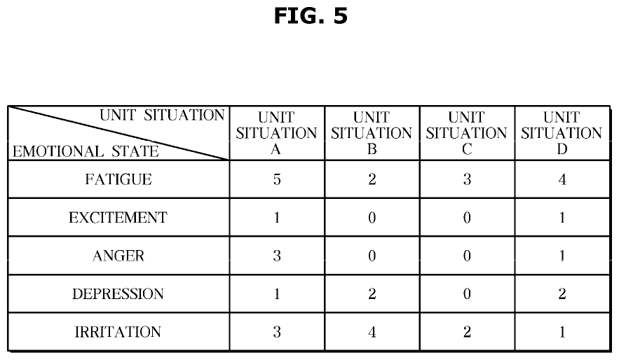

FIG. 4 is a view illustrating a unit situation in accordance with one embodiment. FIG. 5 is a table illustrating situation information representing numbers of expressions of respective emotional states in each unit situation in accordance with one embodiment.

The sensing unit 210 may acquire user emotion information indicating the user's emotional state in real time or periodically during driving of the vehicle 100 and transmit the acquired user emotion information to the controller 260 and the storage 240.

The controller 260 may generate situation information representing numbers of expressions of respective emotional states in each unit situation based on the user emotion information received from the sensing unit 210.

The unit situation may include at least one of a driving situation in a specific distance section, a driving situation in a specific area, and a driving situation in a specific time zone.

Referring to FIG. 4, a situation in which the vehicle 100 is driven in a distance section 410 including an entrance 420 and an exit 430 may become one unit situation. For example, a situation in which the vehicle 100 is driven on a main road in a major city, such as Gangnam-daero, may become one unit situation. A situation in which the vehicle 100 is driven on a specific street, such as Garosu-gil, may become one unit situation. In other words, a situation in which the vehicle 100 is driven in a specific distance section may become one unit situation.

Further, a situation in which the vehicle 100 is driven in a specific area may become one unit situation. For example, a situation in which the vehicle 100 is driven around a specific building may become one unit situation. A situation in which the vehicle 100 is driven in a specific town, such as Namyang-eup, may become one unit situation.

Further, a situation in which the vehicle 100 is driven in a specific time zone may become one unit situation. For example, a situation in which the vehicle 100 is driven during the morning rush hour, in the morning time, during the lunch hour, in the afternoon time, during the evening rush hour, at night, or in the middle of the night may become one unit situation.

The storage 240 may store information regarding the distance section and the area range that may become one unit situation when the vehicle 100 is driven based on GPS position information and map information received by the communicator 230.

Further, the storage 240 may store information of a time zone which may become one unit situation when the vehicle 100 is driven.

In other words, the storage 240 may store unit situation division information indicating the distance section, the area range, and the time zone that may become one unit situation when the vehicle 100 is driven.

The controller 260 may determine a position of the vehicle 100 based on the GPS position information and the map information received by the communicator 230 and determine a current unit situation of the vehicle 100 based on the unit situation division information stored in the storage 240 and the position of the vehicle 100. For example, when the vehicle 100 is driven in the distance section 410, the controller 260 may determine that the current unit situation of the vehicle 100 is a driving situation in the distance section 410.

Further, the controller 260 may determine a time zone in which the vehicle 100 is driven based on current time information received by the communicator 230 and determine the current unit situation of the vehicle 240 based on the unit situation division information stored in the storage 240 and the time zone in which the vehicle 100 is driven.

The controller 260 may generate situation information representing the numbers of expressions of respective emotional states in the unit situation in which the vehicle 100 is driven based on the user emotion information received from the sensing unit 210.

Specifically, the controller 260 may, when the vehicle 100 is driven in a specific unit situation, count the numbers of expressions of respective user's emotional states occurring in the specific unit situation based on the user emotion information during driving of the vehicle 100 and generate situation information based on the numbers of expressions of the user's emotional states at the end point of the specific unit situation.

The controller 260 may generate situation information corresponding to each unit situation that the vehicle 100 faces during driving. Referring to FIG. 5, the situation information in unit situation A represents that the number of expressions of the emotional state of fatigue is 5, the number of expressions of the emotional state of excitement is 1, the number of expressions of the emotional state of anger is 3, the number of expressions of the emotional state of depression is 1, and the number of expressions of the emotional state of irritation is 3. Further, the situation information represents the numbers of expressions of the respective emotional states in unit situation B, unit situation C, and unit situation D. The emotional states and the unit situations shown in FIG. 5 are merely examples. The numbers of expressions of all of the user's emotional states may be represented and all unit situations that the vehicle 100 faces may be considered.

The controller 260 may store situation information generated during previous driving in the storage 240. The situation information during the previous driving may be consistently updated according to the driving of the vehicle 100.

The controller 260 in accordance with one embodiment may confirm the user's emotional state frequently occurring in the current unit situation in which the vehicle 100 is driven based on the situation information stored in the storage 240. The controller 260 may control the feedback devices to prevent the user's emotional state from frequently occurring in the current unit situation. Therefore, the user may positively maintain his/her emotional state and autonomously suppress negative emotions through feedback. Accordingly, the user's ability to control emotions may be enhanced.

The controller 260 in accordance with one embodiment may recognize a current unit situation as the unit situation in which the vehicle 100 is driven in the distance section 410 when the vehicle 100 enters the entrance 420 of the distance section 410.

The controller 260 may compare situation information corresponding to the current unit situation, e.g., the unit situation in which the vehicle 100 is driven in the distance section 410, with a threshold value. The threshold value may be changed according to the user's settings. Hereinafter, the threshold value being set to 4 in accordance with one embodiment is described.

The controller 260 may determine whether or not an emotional state having the number of expressions, which is equal to the threshold value or more, and including a negative emotion factor is present in the situation information corresponding to the current unit situation based on a comparison between the situation information corresponding to the current unit situation and the threshold value.

For example, when the current unit situation is the unit situation A of FIG. 5, the controller 260 may determine that the emotional state of fatigue has the number of expressions, which is the threshold value, e.g., 4, or more, and determine whether or not the emotional state of fatigue includes a negative emotional factor.

Since the emotional state of fatigue includes a negative emotional factor, e.g., the fatigue factor, the controller 260 may determine that the emotional state having the number of expressions, which is equal to the threshold value or more, and including the negative emotion factor is present in the situation information corresponding to the current unit situation.

The controller 260 may control the feedback devices to reduce the negative emotion factor when the emotional state having the number of expressions, which is equal to the threshold value or more, and including the negative emotion factor is present in the situation information corresponding to the current unit situation.

The feedback devices may include at least one of the communicator 230, the speakers 250, the display 270, a side window opening and closing device, and the air conditioner of the vehicle 100.

The controller 260 may control various kinds of feedback devices to provide visual, auditory, and tactile feedback and differently control the feedback devices according to the kinds of emotional states corresponding to the negative emotion factors.

The controller 260 may reduce the negative emotion factor by controlling the communicator 230 to make a call with a family member or a friend of the user based on acquired phone numbers. A call may be made through the communicator 230 or be made through the user's mobile device connected to the communicator 230.

The controller 260 may reduce the negative emotion factor by controlling the speakers 250 to reproduce music by controlling at least one of the volume, genre, equalization, tone, and wave band of music or to reproduce an emotion release message inducing the user to release negative emotions.

The volume, genre, equalization, tone, and wave band of the music may be controlled to be varied according to the kinds of the emotional states corresponding to the negative emotion factors. Further, the emotion release message may be varied according to the kinds of the emotional states that are subject to feedback.

For example, the controller 260 may control the speakers 250 to reproduce classical music when the emotional state that is subject to feedback is anger. The controller 260 may control the speaker 250 to reproduce dance music when the emotional state that is subject to feedback is depression.

The controller 260 may reduce the negative emotion factor by controlling the display 270 to display an emotion release image inducing the user to release negative emotions. The emotion release image may be varied according to the kinds of the emotional states corresponding to the negative emotion factors.

The controller 260 may reduce the negative emotion factor by controlling the side window opening and closing device to open and close the side windows to lower the internal temperature of the vehicle 100 and promote air flow in the vehicle 100.

The controller 260 may reduce the negative emotion factor by controlling the air conditioner to lower the internal temperature of the vehicle 100.

When the emotional state having the number of expressions, which is equal to the threshold value or more, and including the negative emotion factor is not present in the situation information corresponding to the current unit situation, the controller 260 may control the sensing unit 210 to acquire user emotion information indicating the user's emotional state using the sensors.

The sensing unit 210 may acquire the user emotion information indicating the user's emotional state using the sensors.

The controller 260 may determine whether or not the negative emotion factor of the emotional state included in the user emotion information is equal to a reference value or more based on the user emotion information received from the sensing unit 210.

Specifically, the controller 260 may determine whether or not a value of the negative emotion factor included in the user emotion information is equal to the reference value or more. The reference value may be determined by the user's settings. Such a reference value is a value set to determine whether or not the user's emotional state requires control of the feedback devices.

When the value of the negative emotion factor indicating a degree of a negative emotion is equal to the reference value or more, the controller 260 may control the feedback devices to reduce the negative emotion factor.

The feedback devices may include at least one of the communicator 230, the speakers 250, the display 270, the side window opening and closing device, and the air conditioner of the vehicle 100. The controller 260 may control the feedback devices to reduce the negative emotion factor.

Further, when the user emotion information includes a fatigue factor, the controller 260 may reduce the negative emotion factor by controlling an autonomous drive system to switch the current mode of the vehicle to an autonomous driving mode to move the vehicle 100 to a place where the user may take a rest.

Further, when the user emotion information includes an excitement factor caused by drinking, the controller 260 may control the autonomous drive system to switch the current mode of the vehicle to the autonomous driving mode.

Further, when the user emotion information includes an anger factor, the controller 260 may prevent acceleration or retaliatory driving of the vehicle 100 by controlling an accelerator pedal device to reduce reactivity of an accelerator pedal of the vehicle 100.

The controller 260 may vary the kinds of feedback devices that are controlled and vary the kinds and number of the feedback devices that are simultaneously controlled according to degrees of the user's current emotional state based on the value of the negative emotion factor.

When the value of the negative emotion factor of the emotional state indicated by the user emotion information is less than the reference value, the controller 260 may determine whether or not the unit situation is changed.

Further, the controller 260 may determine whether or not the unit situation is changed after control of the feedback devices to reduce the negative emotion factor.

Specifically, the controller 260 may determine whether or not the unit situation is changed based on the unit situation division information stored in the storage 240. The controller 260 may determine whether or not the current unit situation in which the vehicle 100 is driven is changed to another unit situation based on the unit situation division information.

For example, when the current unit situation is the unit situation in which the vehicle 100 is driven in the distance section 410 of FIG. 4, the controller 260 may determine whether or not the unit situation is changed according to passage of the vehicle 100 through the exit 430.

When it is determined that the unit situation is changed, the controller 260 may update the situation information corresponding to the unit situation prior to the change. Specifically, the controller 260 may update the situation information corresponding to the unit situation prior to the change, which is stored based on the numbers of expressions of the respective emotional states counted by the sensing unit 210 in the unit situation prior to the change.

When it is determined that the unit situation is not changed, the controller 260 may acquire user emotion information indicating the user's emotional state again using the sensors. When the value of the negative emotion factor influencing the emotional state measured after control of the feedback devices is equal to the reference value or more, the controller 260 may control the feedback devices again to reduce the negative emotion factor influencing the emotional state.

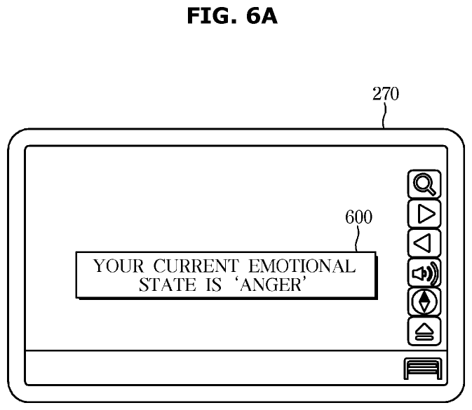

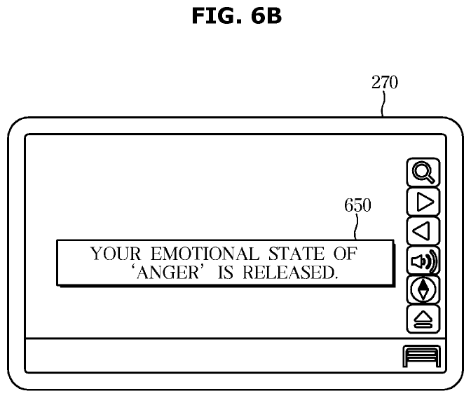

FIGS. 6A and 6B are views illustrating the user's emotional state guide screens displayed on the display 270 of the vehicle in accordance with one embodiment.

The controller 260 may recognize the user's current emotional state based on user emotion information. The controller 260 may control the display 270 to display the recognized user's current emotional state.

Referring to FIG. 6A, when the user's current emotional state determined by the controller 260 is anger, the display 270 may display an emotional state message 600 stating, “your current emotional state is anger.” Accordingly, the user may recognize the current emotional state.

Further, the controller 260 may control the speakers 250 to output the determined user's current emotional state. When the user's current emotional state determined by the controller 260 is anger, the speakers 250 may output an emotional state message with a voice saying, “your current emotional state is anger.” Accordingly, the user may recognize the current emotional state.

The emotional state message corresponding to the user's current emotional state may be transmitted to the user through the display 270 or the speakers 250, thereby allowing the user to recognize his/her current emotional state.

Further, the controller 260 may differently control the feedback devices according to the determined user's current emotional state. For example, when the determined user's current emotional state is anger, the controller 260 may control the speakers 250 to reproduce classical music. When the determined user's current emotional state is depression, the controller 260 may control the speakers 250 to reproduce dance music. Accordingly, the user may recognize his/her current emotional state according to output of the feedback devices executed under control of the controller 260.

Further, the controller 260 may control the display 270 to display the emotional state determined after control of the feedback devices.

Referring to FIG. 6B, when it is determined that the emotional state of anger prior to control of the feedback devices is released based on the emotional state determined after control of the feedback devices, the display 270 may display an emotional state message 650 stating, “your emotional state of anger is released.” Accordingly, the user may recognize that his/her emotional state prior to control of the feedback devices is released.

Further, the controller 260 may control the speakers 250 to output the user's current emotional state determined after control of the feedback devices. When it is determined that the emotional state of anger prior to control of the feedback devices is released based on the user's emotional state determined after control of the feedback devices, the speakers 250 may output an emotional state message with a voice saying, “your emotional state of anger is released.” Accordingly, the user may recognize that his/her emotional state prior to control of the feedback devices is released.

The emotional state message indicating that the emotional state prior to control of the feedback devices is released may be transmitted to the user through the display 270 or the speakers 250, thereby allowing the user to recognize his/her current emotional state.

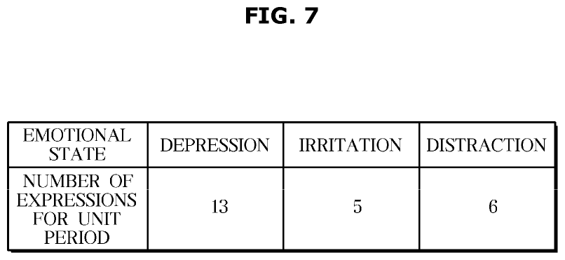

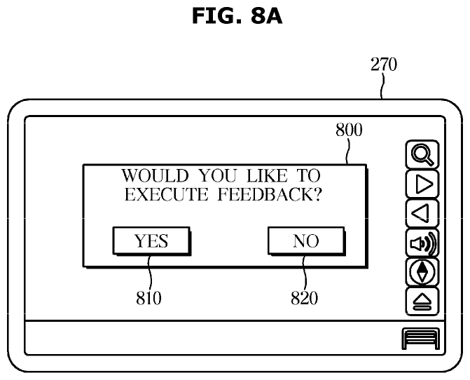

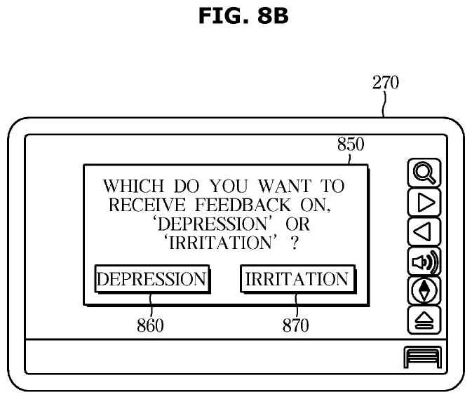

FIG. 7 is a table illustrating user long-term information representing the numbers of expressions of respective emotional states for a unit period in accordance with one embodiment. FIGS. 8A and 8B are views illustrating screens displayed on the display to receive user selection in the vehicle in accordance with one embodiment.

The controller 260 may count the numbers of expressions of user's emotional states expressed for a unit period based on the user emotion information acquired through the sensing unit 210. Therethrough, the controller 260 may generate user long-term information representing the counted numbers of expressions of the user's emotional states for the unit period.

The generated user long-term information may be stored in the storage 240. The user long-term information may be stored or updated at an interval of a unit period. The unit period may be set to a week and be changed according to user's settings.

Referring to FIG. 7, the user long-term information generated by the controller 260 may represent the numbers of expressions of the emotional states for the unit period. For example, the user long-term information may represent that the number of expressions of the emotional state of depression is 13, the number of expressions of the emotional state of irritation is 5, and the number of expressions of the emotional state of distraction is 6 for the corresponding unit period. The emotional states shown in FIG. 7 are merely examples. The user long-term information may represent the numbers of expressions of all of user's emotional states.

The controller 260 may store user long-term information generated during previous driving in the storage 240 and the user long-term information during previous driving may be consistently updated according to driving of the vehicle 100.

The controller 260 in accordance with one embodiment may confirm the user's emotional state frequently occurring for the unit period based on the user long-term information stored in the storage 240. The controller 260 may control the feedback devices to prevent the user's emotional state frequently occurring for the unit period. Therefore, the user may positively maintain his/her emotional state and autonomously suppress negative emotions through feedback. Accordingly, the user's ability to control emotions may be enhanced.

The controller 260 may compare the user long-term information with a threshold value when a current date corresponds to a reference date. The reference date may be a specific date to provide feedback on an emotion frequently occurring for the unit period using the user long-term information. The reference date may be changed according to the user's settings. Further, the threshold value may be changed according to the user's settings. Hereinafter, the threshold value set to 10 in accordance with one embodiment is described.

The controller 260 may determine whether or not an emotional state having the number of expressions, which is equal to the threshold value or more, and including a negative emotion factor is present in the user long-term information based on a comparison between the user long-term information and the threshold value.

For example, when the user long-term information is the user long-term information shown in FIG. 7, the controller 260 may determine that the emotional state of depression has the number of expressions, which is more than the threshold value, e.g., 10, and determine whether or not the emotional state of depression includes a negative emotional factor.

Since the emotional state of depression includes the negative emotional factor, e.g., the depression factor, the controller 260 may determine that an emotional state having the number of expressions, which is equal to the threshold value or more, and including the negative emotion factor is present in the situation information corresponding to the current unit situation.

When the emotional state having the number of expressions, which is equal to the threshold value or more, and including the negative emotion factor is present in the user long-term information, the controller 260 may confirm whether or not the user agrees to execution of feedback on the frequently occurring user's emotional state.

Referring to FIG. 8A, the controller 260 may control the display 270 to display a confirmation message 800 to confirm whether or not the user agrees to execution of feedback, such as “would you like to execute feedback?”. The confirmation message 800 may include a button 810 indicating agreement on execution of feedback, such as “yes,” and a button 820 indicating refusal on execution of feedback, such as “no.”

The user may input a response indicating whether he or she agrees to execution of feedback by selecting one of the buttons 810 or 820 of the confirmation message 800 using the buttons 221a provided around the display 270, the jog-shuttle 211b provided between the driver's seat 72 and the front passenger's seat 73, or the touchpad provided on the front surface of the display 270.

Further, the user may input a response indicating whether he or she agrees to execution of feedback by voice using the microphone 222.

When the user agrees to execution of feedback, the controller 260 may select the emotional state having the number of expressions, which is equal to the threshold value or more, and including the negative emotion factor in the user long-term information as an emotional state that is subject to feedback.

When there are a plurality of emotional states having the number of expressions, which are equal to the threshold value or more, and including the negative emotion factor, the controller 260 may select an emotional state having the greatest number of expressions.

When there are a plurality of emotional states having the number of expressions, which is equal to the threshold value or more, and including the negative emotion factor, the controller 260 may receive user selection of the emotional state that is subject to feedback among the emotional states having the greatest number of expressions from the user when there are a plurality of the emotional states having the greatest number of expressions.

Referring to FIG. 8B, the controller 260 may control the display 270 to display a request message 850 to request selection of the emotional state that is subject to feedback from the user, such as “which do you want to receive feedback on, depression or irritation?”. The request message 850 may include an emotional state list 860 and 870 including the emotional states having the greatest number of expressions in the user long-term information, such as “depression” and “irritation.” The emotional states shown in FIGS. 8A and 8B are merely examples. A request message 850 and an emotional state list about all of user's emotional states may be displayed.

The user may input a desired emotional state that is subject to feedback by selecting the desired emotional state that is subject to feedback of the emotional state list in the request message 850 using the buttons 221a provided around the display 270, the jog-shuttle 211b provided between the driver's seat 72 and the front passenger's seat 73, or the touchpad provided on the front surface of the display 270.

Further, the user may input the desired emotional state that is subject of feedback by voice using the microphone 222.

The controller 260 may control the feedback devices to reduce the negative emotion factor influencing the selected emotional state.

The feedback devices may include at least one of the communicator 230, the speakers 250, the display 270, the side window opening and closing device, and the air conditioner of the vehicle 100.

The controller 260 may control various kinds of feedback devices to provide visual, auditory and tactile feedback, and differently control the feedback devices according to the kinds of emotional states corresponding to the negative emotion factors.

The controller 260 may reduce the negative emotion factor by controlling the communicator 230 to make a call with a family member or a friend of the user based on acquired phone numbers. The call may be made through the communicator 230 or be made through the user's mobile device connected to the communicator 230.

The controller 260 may reduce the negative emotion factor by controlling the speakers 250 to reproduce music by controlling at least one of the volume, genre, equalization, tone, and wave band of music or to reproduce an emotion release message inducing the user to release negative emotions.

The volume, genre, equalization, tone, and wave band of the music may be controlled to be varied according to the kinds of the emotional states corresponding to the negative emotion factors. Further, the emotion release message may be varied according to the kinds of the emotional states that are subject to feedback.

For example, when the emotional state that is subject to feedback is anger, the controller 260 may control the speakers 250 to reproduce classical music. When the emotional state that is subject to feedback is depression, the controller 260 may control the speakers 250 to reproduce dance music.

The controller 260 may reduce the negative emotion factor by controlling the display 270 to display an emotion release image inducing the user to release negative emotion. The emotion release image may be varied according to the kinds of the emotional states corresponding to the negative emotion factors.

The controller 260 may reduce the negative emotion factor by controlling the side window opening and closing device to open and close the side windows to lower the internal temperature of the vehicle 100 and promote air flow in the vehicle 100.

The controller 260 may reduce the negative emotion factor by controlling the air conditioner to lower the internal temperature of the vehicle 100.

Hereinafter, a control method of a vehicle in accordance with one embodiment is described. The vehicle 100 in accordance with the above-described embodiment may be applied to the control method. Therefore, the above description given with reference to the FIGS. 1 to 8B may be applied to the control method unless stated otherwise.

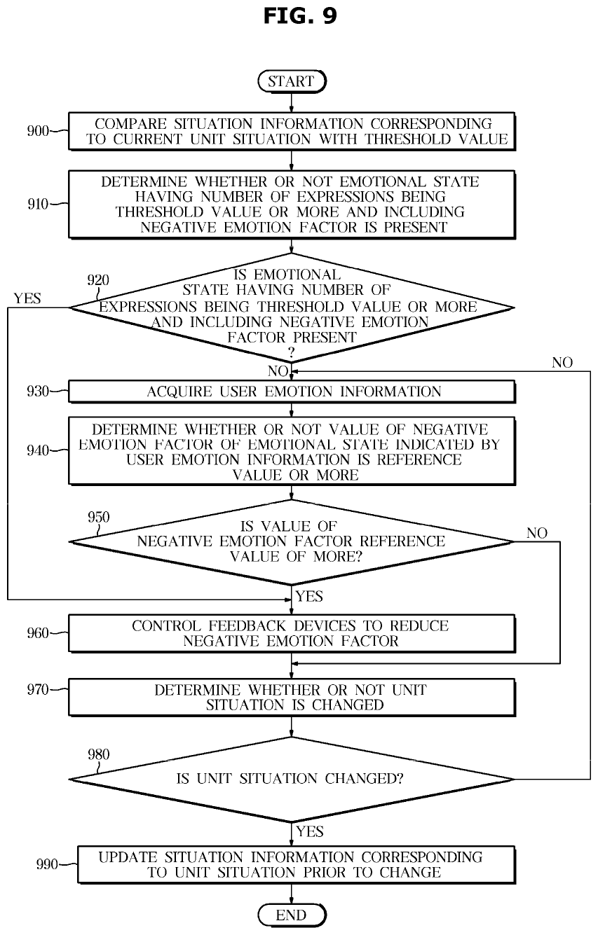

FIG. 9 is a flowchart illustrating a control method of a vehicle in accordance with one embodiment.

The controller 260 may compare situation information corresponding to a current unit situation with a threshold value (900).

The controller 260 may determine whether or not an emotional state having the number of expressions, which is equal to the threshold value or more, and including a negative emotion factor is present in the situation information corresponding to the current unit situation based on the comparison between the situation information corresponding to the current unit situation and the threshold value (910).

When the emotional state having the number of expressions, which is equal to the threshold value or more, and including the negative emotion factor is present in the situation information corresponding to the current unit situation (Yes in 920), the controller 260 may control the feedback devices to reduce the negative emotion factor (960).

The controller 260 may control the feedback devices to reduce the negative emotion factor influencing the selected emotional state.

The feedback devices may include at least one of the communicator 230, the speakers 250, the display 270, the side window opening and closing device, and the air conditioner of the vehicle 100.

The controller 260 may control various kinds of feedback devices to provide visual, auditory, and tactile feedback and differently control the feedback devices according to the kinds of emotional states corresponding to negative emotion factors.

The controller 260 may reduce the negative emotion factor by controlling the communicator 230 to make a call with a family member or a friend of the user based on acquired phone numbers. The call may be made through the communicator 230 or be made through the user's mobile device connected to the communicator 230.

The controller 260 may reduce the negative emotion factor by controlling the speakers 250 to reproduce music by controlling at least one of the volume, genre, equalization, tone, and wave band of music or to reproduce an emotion release message inducing the user to release negative emotions.

The volume, genre, equalization, tone, and wave band of the music may be controlled to be varied according to the kinds of the emotional states corresponding to the negative emotion factors. Further, the emotion release message may be varied according to the kinds of the emotional states which are subject to feedback.

For example, when the emotional state that is subject to feedback is anger, the controller 260 may control the speakers 250 to reproduce classical music. When the emotional state that is subject to feedback is depression, the controller 260 may control the speakers 250 to reproduce dance music.

The controller 260 may reduce the negative emotion factor by controlling the display 270 to display an emotion release image inducing the user to release negative emotions. The emotion release image may be varied according to the kinds of the emotional states corresponding to the negative emotion factors.

The controller 260 may reduce the negative emotion factor by controlling the side window opening and closing device to open and close the side windows to lower the internal temperature of the vehicle 100 and promote air flow in the vehicle 100.

The controller 260 may reduce the negative emotion factor by controlling the air conditioner to lower the internal temperature of the vehicle 100.

When the emotional state having the number of expressions, which is equal to the threshold value or more, and including the negative emotion factor is not present in the situation information corresponding to the current unit situation (No in 920), the controller 260 may acquire user emotion information (930).

Specifically, the sensing unit 210 may acquire the user emotion information indicating the user's emotional state. The controller 260 may receive the user emotion information indicating the user's emotional state from the sensing unit 210.

The controller 260 may determine whether or not the negative emotion factor of the emotional state indicated by the user emotion information is equal to a reference value or more based on the user emotion information received from the sensing unit 210 (940).

Specifically, the controller 260 may determine whether or not a value of the negative emotion factor included in the user emotion information is equal to the reference value or more. The reference value may be determined by user's settings. Such a reference value is a value set to determine whether or not the user's emotional state requires control of the feedback devices.

When the value of the negative emotion factor indicating a degree of the negative emotion is equal to the reference value or more (Yes in 950), the controller 260 may control the feedback device to reduce the negative emotion factor (960).

The feedback devices may include at least one of the communicator 230, the speakers 250, the display 270, the side window opening and closing device, and the air conditioner of the vehicle 100. The controller 260 may control the feedback devices to reduce the negative emotion factor.

Further, when the user emotion information includes a fatigue factor, the controller 260 may reduce the negative emotion factor by controlling the autonomous drive system to switch the current mode of the vehicle to the autonomous driving mode and to move the vehicle 100 to a place where the user may take a rest.

Further, when the user emotion information includes an excitement factor caused by drinking, the controller 260 may control the autonomous drive system to switch the current mode of the vehicle to the autonomous driving mode.

Further, when the user emotion information includes an anger factor, the controller 260 may prevent acceleration or retaliatory driving of the vehicle 100 by controlling the accelerator pedal device to reduce reactivity of the accelerator pedal of the vehicle 100.

The controller 260 may vary the kinds of feedback devices that are controlled and vary the number of the feedback devices that are simultaneously controlled according to degrees of the user's current emotional state based on the value of the negative emotion factor.

When the value of the negative emotion factor of the emotional state indicated by the user emotion information is less than the reference value (No in 950) or after control of the feedback devices in 960, the controller 260 may determine whether or not the unit situation is changed (970).

Specifically, the controller 260 may determine whether or not the unit situation is changed based on unit situation division information stored in the storage 240. The controller 260 may determine whether or not the current unit situation in which the vehicle 100 is driven is changed to another unit situation based on the unit situation division information.

When it is determined that the unit situation is changed (Yes in 980), the controller 260 may update the situation information corresponding to the unit situation prior to the change (990). Specifically, the controller 260 may update the situation information corresponding to the unit situation prior to the change, which is stored based on the numbers of expressions of the respective emotional states counted by the sensing unit 210 in the unit situation prior to the change.

When it is determined that the unit situation is not changed (No in 980), the controller 260 may acquire user emotion information again (930) and determine whether or not the value of the negative emotion factor influencing the emotional state measured after control of the feedback devices is equal to the reference value or more (940). Accordingly, whether or not the feedback devices are controlled to reduce the negative emotion factor influencing the emotional state are determined.

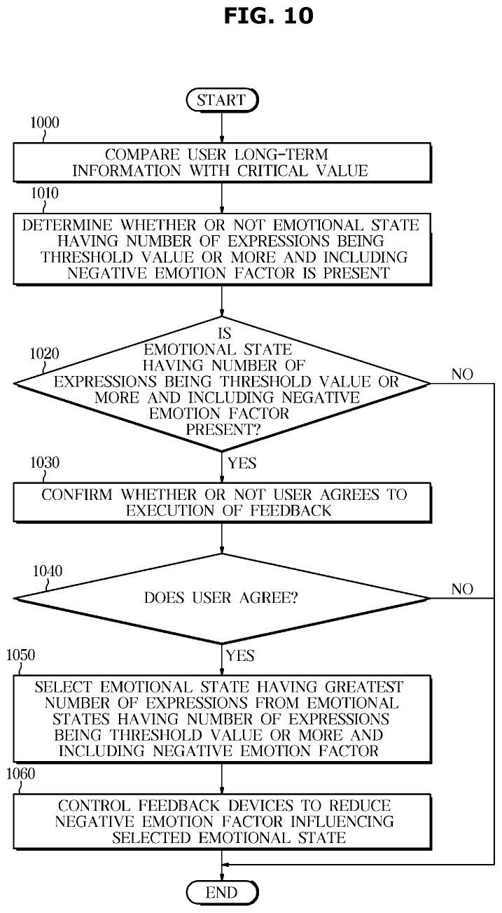

FIG. 10 is a flowchart illustrating another control method of a vehicle in accordance with one embodiment.

Referring to FIG. 10, the controller 260 may compare user long-term information with a threshold value when a current date corresponds to a reference date (1000). The reference date may be a specific date to provide feedback on an emotion frequently occurring for a unit period using the user long-term information. The reference date may be changed according to user's settings. Further, the threshold value may be changed according to the user's settings. Hereinafter, the threshold value set to 10 in accordance with one embodiment is described.

The controller 260 may determine whether or not an emotional state having the number of expressions, which is equal to the threshold value or more, and including a negative emotion factor is present in the user long-term information, based on the comparison between the user long-term information and the threshold value (1010).

When the emotional state having the number of expressions, which is equal to the threshold value or more, and including the negative emotion factor is present in the user long-term information (Yes in 1020), the controller 260 may confirm whether or not the user agrees to execution of feedback on the frequently occurring user's emotional state (1030).

The controller 260 may control the display 270 to display a confirmation message to confirm whether or not the user agrees to execution of feedback, such as “would you like to execute feedback?”. The confirmation message may include a button indicating agreement on execution of the feedback, such as “yes,” and a button indicating refusal on execution of the feedback, such as “no.”

The user may input a response indicating whether he or she agrees to execution of the feedback by selecting one of the buttons of the confirmation message using the buttons 221a provided around the display 270, the jog-shuttle 211b provided between the driver's seat 72 and the front passenger's seat 73, or the touchpad provided on the front surface of the display 270.

Further, the user may input a response indicating whether he or she agrees to execution of feedback by voice using the microphone 222.

When the user agrees to execution of feedback (Yes in 1040), the controller 260 may select an emotional state having the greatest number of expressions among the emotional states having the number of expressions, which are equal to the threshold value or more, and including the negative emotion factor in the user long-term information (1050).

In more detail, the controller 260 may select the emotional state having the greatest number of expressions as an emotional state that is subject to feedback among the emotional states having the number of expressions, which are equal to the threshold value or more, and including the negative emotion factor in the user long-term information.

In other words, the controller 260 may select one emotional state having the greatest number of expressions when there are a plurality of emotional states having the number of expressions, which are equal to the threshold value or more, and including the negative emotion factor in the user long-term information. The controller 260 may select the emotional state when there is one emotional state having the number of expressions, which is equal to the threshold value or more, and including the negative emotion factor in the user long-term information.

Further, the controller 260 may receive user selection of the emotional state that is subject to feedback among the emotional states having the greatest number of expressions from the user when there are a plurality of emotional states having the number of expressions, which are equal to the threshold value or more, and including the negative emotion factor and there are a plurality of emotional states having the greatest number of expressions.

For example, the controller 260 may control the display 270 to display a request message to request selection of the emotional state which is subject to feedback from the user, such as “which do you want to receive feedback on, depression or irritation?”. The request message may include an emotional state list including the emotional states having the greatest number of expressions in the user long-term information, such as “depression” and “irritation.”

The user may input a desired emotional state that is subject to feedback by selecting the desired emotional state that is subject to feedback of the emotional state list in the request message using the buttons 221a provided around the display 270, the jog-shuttle 211b provided between the driver's seat 72 and the front passenger's seat 73, or the touchpad provided on the front surface of the display 270.

Further, the user may input the desired emotional state that is subject to feedback by voice using the microphone 222.

The controller 260 may control the feedback devices to reduce the negative emotion factor influencing the selected emotional state (1060).

The feedback devices may include at least one of the communicator 230, the speakers 250, the display 270, the side window opening and closing device, and the air conditioner of the vehicle 100.

The controller 260 may control various kinds of feedback devices to provide visual, auditory, and tactile feedback, and differently control the feedback devices according to the kinds of emotional states corresponding to the negative emotion factors.

The controller 260 may reduce the negative emotion factor by controlling the communicator 230 to make a call with a family member or a friend of the user based on acquired phone numbers. The call may be made through the communicator 230 or be made through the user's mobile device connected to the communicator 230.

The controller 260 may reduce the negative emotion factor by controlling the speakers 250 to reproduce music by controlling at least one of the volume, genre, equalization, tone, and wave band of music or to reproduce an emotion release message inducing the user to release negative emotions.

The volume, genre, equalization, tone, and wave band of the music may be controlled to be varied according to the kinds of the emotional states corresponding to the negative emotion factors. Further, the emotion release message may be varied according to the kinds of the emotional states that are subject to feedback.

For example, when the emotional state that is subject to feedback is anger, the controller 260 may control the speakers 250 to reproduce classical music. When the emotional state that is subject to feedback is depression, the controller 260 may control the speakers 250 to reproduce dance music.

The controller 260 may reduce the negative emotion factor by controlling the display 270 to display an emotion release image inducing the user to release negative emotions. The emotion release image may be varied according to the kinds of the emotional states corresponding to the negative emotion factors.

The controller 260 may reduce the negative emotion factor by controlling the side window opening and closing device to open and close the side windows to lower the internal temperature of the vehicle 100 and promote air flow in the vehicle 100.

The controller 260 may reduce the negative emotion factor by controlling the air conditioner to lower the internal temperature of the vehicle 100.

According to the embodiments of the vehicle and the control method thereof described herein, the user's negative emotions can be prevented and suppressed by reflecting the emotional state of the user and providing feedback.

As is apparent from the above description, a vehicle and a control method thereof in accordance with one embodiment may determine the user's emotional state and then provides feedback to the user based on the determined user's emotional state, thereby preventing and releasing the user's negative emotions.

Although a few embodiments of the present disclosure have been shown and described, it would be appreciated by those of ordinary skill in the art that changes may be made in these embodiments without departing from the principles and spirit of the disclosure, the scope of which is defined in the claims and their equivalents. It is intended that the embodiments and the accompanying drawings are merely to describe the technical scope and spirit of the present disclosure without limitation of the technical scope and spirit of the present disclosure.

What is claimed is:

1. A vehicle comprising:
a sensing unit configured to acquire user emotion information indicating an emotional state of a user using at least one sensor;
a storage configured to store situation information representing a plurality of expressions of emotional states in a unit situation and user long-term information representing the plurality of expressions of the emotional states for a unit period based on the acquired user emotion information; and
a controller configured to control feedback devices provided in the vehicle to control the emotional state of the user based on at least one of the situation information, the user long-term information, and the user emotion information.

2. The vehicle according to 1, further comprising a display configured to display the emotional state of the user based on the user emotion information.

3. The vehicle according to 1, wherein the controller compares the situation information corresponding to a current unit situation with a first threshold value and, when a first emotional state having the plurality of expressions and including a negative emotion factor indicating a negative emotional state of the user is present, controls the feedback devices to reduce the negative emotion factor influencing the first emotional state,
wherein the plurality of expressions is equal to or more than the first threshold value, and
wherein the unit situation comprises at least one of a driving situation in a specific time zone, a driving situation in a specific distance section, and a driving situation in a specific area.

4. The vehicle according to claim 3, wherein, when the first emotional state having the plurality of expressions, which is equal to or more than the first threshold value, is not present and a value of the negative emotion factor influencing a second emotional state indicated by current user emotion information is equal to or more than a reference value, the controller controls the feedback devices to reduce the negative emotion factor influencing the second emotional state.

5. The vehicle according to claim 4, wherein, when the value of the negative emotion factor influencing the emotional state indicated by the user emotion information acquired after control of the feedback devices is equal to or more than the reference value, the controller controls the feedback devices to reduce the negative emotion factor influencing the emotional state.

6. The vehicle according to claim 5, wherein when the current unit situation is changed to another unit situation, the controller updates the situation information corresponding to the unit situation prior to the change based on the user emotion information measured in the unit situation prior to the change.

7. The vehicle according to claim 1, wherein the controller compares the user long-term information with a second threshold value and, when a third emotional state having the plurality of expressions and including a negative emotion factor indicating a negative emotional state of the user is present, controls the feedback devices to reduce the negative emotion factor influencing the third emotional state,
wherein the plurality of expressions is equal to or more than the second threshold value.

8. The vehicle according to claim 7, further comprising an input unit configured to receive user input,
wherein, when the third emotional state comprises a plurality of third emotional states, the controller selects one third emotional state of the plurality of third emotional states based on at least one of a greatest number of expressions present in the plurality of third emotional states and the user input regarding the plurality of third emotional states.

9. The vehicle according to claim 8, wherein the controller controls the feedback devices based on the user input with respect to a message to suggest control of the feedback devices.

10. The vehicle according to claim 1, wherein the feedback devices comprise at least one of a communicator configured to make a call, a speaker configured to reproduce music and an emotion release message, a display configured to display an emotion release image, a side window opening and closing device configured to open and close a side window, and an air conditioner configured to control an internal temperature of the vehicle.

11. A control method of a vehicle comprising:
acquiring user emotion information indicating an emotional state of a user using at least one sensor;
storing situation information representing a plurality of expressions of emotional states in a unit situation and user long-term information representing the plurality of expressions of the emotional states for a unit period based on the acquired user emotion information; and
controlling feedback devices provided in the vehicle to control the emotional state of the user based on at least one of the situation information, the user long-term information, and the user emotion information.

12. The control method according to 11, further comprising displaying the emotional state of the user based on the user emotion information.

13. The control method according to 11, further comprising:
comparing the situation information corresponding to a current unit situation with a first threshold value; and
controlling the feedback devices to reduce a negative emotion factor indicating a negative emotional state of the user influencing a first emotional state when the first emotional state having the plurality of expressions and including the negative emotion factor is present,
wherein the plurality of expressions is equal to or more than the first threshold value, and
wherein the unit situation comprises at least one of a driving situation in a specific time zone, a driving situation in a specific distance section, and a driving situation in a specific area.

14. The control method according to claim 13, further comprising:
controlling the feedback devices to reduce the negative emotion factor influencing a second emotional state when the first emotional state having the plurality of expressions, which is equal to or more than the first threshold value, is not present and a value of the negative emotion factor influencing the second emotional state indicated by current user emotion information is equal to or more than a reference value.

15. The control method according to claim 14, further comprising:
when the value of the negative emotion factor influencing the emotional state indicated by the user emotion information acquired after control of the feedback devices is equal to or more than the reference value, controlling the feedback devices to reduce the negative emotion factor influencing the emotional state.

16. The control method according to claim 15, further comprising:
updating the situation information corresponding to the unit situation prior to the change based on the user emotion information measured in the unit situation prior to the change when the current unit situation is changed to another unit situation.

17. The control method according to claim 11, further comprising:
comparing the user long-term information with a second threshold value; and
controlling the feedback devices to reduce a negative emotion factor indicating a negative emotional state of a user and influencing a third emotional state when the third emotional state having the plurality of expressions, which is equal to or more than the second threshold value and including the negative emotion factor is present.

18. The control method according to claim 17, further comprising:
receiving user input; and
selecting the third emotional state based on at least one of a greatest number of expressions present in the third emotional state and the user input regarding the third emotional state,
wherein the third emotional state comprises a plurality of third emotional states.

19. The control method according to claim 18, further comprising controlling the feedback devices based on the user input with respect to a message to suggest control of the feedback devices.

20. The control method according to claim 11, wherein the feedback devices comprise at least one of a communicator configured to make a call, a speaker configured to reproduce music and an emotion release message, a display configured to display an emotion release image, a side window opening and closing device configured to open and close a side window, and an air conditioner configured to control an internal temperature of the vehicle.
